(19) United States
(12) Patent Application Publication
(10) Pub. No.: US 2012/0099245 A1
(43) Pub. Date: Apr. 26, 2012

(54) LITHIUM ION CAPACITOR AND MANUFACTURING METHOD OF LITHIUM ION CAPACITOR

(75) Inventors: Ji Sung CHO, Gyeonggi-do (KR); Sang Kyun Lee, Gyeonggi-do (KR); Bae Kyun Kim, Gyeonggi-do (KR)

(73) Assignee: SAMSUNG ELECTRO-MECHANICS CO., LTD.

(21) Appl. No.: 13/214,669

(22) Filed: Aug. 22, 2011

(30) Foreign Application Priority Data
Oct. 21, 2010 (KR) 10-2010-0102787

(51) Int. Cl. H01G 9/035; H01G 9/042

(52) U.S. Cl. 361/505; 29/25.03

(57) ABSTRACT

Disclosed herein are a lithium ion capacitor (LIC) including: a positive electrode including a positive electrode activated material; a negative electrode including a negative electrode activated material; and an electrolyte solution disposed between the positive electrode and the negative electrode, wherein the positive electrode activated material includes graphite, thereby making it possible to considerably improve capacitance of a lithium ion capacitor as compared to a lithium ion capacitor according to the related art, and a manufacturing method of the lithium ion capacitor.

### CROSS REFERENCE(S) TO RELATED APPLICATIONS

This application claims the benefit under 35 U.S.C. Section 119 of Korean Patent Application Serial No. 10-2010-0102787, entitled “Lithium Ion Capacitor and Manufacturing Method of Lithium Ion Capacitor” filed on Oct. 21, 2010, which is hereby incorporated by reference in its entirety into this application.

### BACKGROUND OF THE INVENTION

1. Technical Field

The present invention relates to a lithium ion capacitor (LIC) and a manufacturing method of the lithium ion capacitor, and more particularly, to a lithium ion capacitor having improved capacitance by using graphite as a positive electrode activated material and a manufacturing method of the lithium ion capacitor.

2. Description of the Related Art

A device called an ultracapacitor or a supercapacitor of energy storage devices has been spotlighted as the next-generation energy storage device due to rapid charging and discharging speed, high stability, and environmentally-friendly characteristics.

A general supercapacitor is configured of an electrode structure, a separator, an electrolyte solution, and the like. The supercapacitor is driven based on an electrochemical reaction mechanism that carrier ions in the electrolyte solution are selectively adsorbed to the electrode by applying power to the electrode structure.

At the present time, there is a lithium ion capacitor (LIC) as a representative supercapacitor. The general lithium ion capacitor has an electrode structure that includes a positive electrode made of an active carbon and a negative electrode made of various kinds of carbon material (for example, graphite, soft carbon, and hard carbon), etc. The process for manufacturing a lithium ion capacitor includes an electrode manufacturing process forming an electrode structure by repeatedly stacking a positive electrode, a separator, and a negative electrode in sequence, a terminal welding process welding positive and negative terminals to the electrode structure, a lithium ion doping process previously doping the negative electrode with lithium ions (Li⁺), and the like.

The representative lithium doping process according to the related art prepares a doping bath filled with the electrolyte solution and disposes the electrode structure and a lithium containing doping plate disposed to be opposite to the electrode structure in the doping bath. The negative electrode is doped with the lithium ions in the doping plate by repeatedly performing a charging process of applying voltage to the positive electrode and the negative electrode and a discharging process of applying voltage to the positive electrode and a lithium metal plate several times.

Meanwhile, the lithium ion capacitor has a variety of advantages; however, characteristics such as capacitance, etc., should be improved in order to be actually applied to various fields. Research into improving characteristics such as capacitance, etc., of the lithium ion capacitor has been continuously conducted.

### SUMMARY OF THE INVENTION

An object of the present invention is to improve capacitance of a lithium ion capacitor as compared to a lithium ion capacitor according to the related art.

Another object of the present invention is to provide a lithium ion capacitor having improved capacitance by including graphite as a positive electrode activated material, and a manufacturing method of the lithium ion capacitor.

According to an exemplary embodiment of the present invention, there is provided a lithium ion capacitor, including: a positive electrode including a positive electrode activated material; a negative electrode including a negative electrode activated material; and an electrolyte solution disposed between the positive electrode and the negative electrode, wherein the positive electrode activated material includes graphite.

The graphite may have an interlayer distance of 0.35 to 0.38 nm.

The positive electrode activated material may be capable of performing reversible adsorption/desorption of ions in the potential of 2.0 to 3.0V with respect to the lithium ion.

The positive electrode and/or the negative electrode may be pre-doped with the lithium ions.

The doped positive electrode may have the potential of 2.1V or less with respect to the lithium ion, and the doped negative electrode may have the potential of 0.1V or less with respect to the lithium ion.

According to another exemplary embodiment of the present invention, there is provided a manufacturing method of a lithium ion capacitor including a positive electrode including a positive electrode activated material; a negative electrode including a negative electrode activated material; and an electrolyte solution disposed between the positive electrode and the negative electrode, including: heat-treating graphite in preparing the positive electrode activated material.

The heat-treatment may be performed at a temperature of 650 to 800° C. for five to eight hours.

The manufacturing method of a lithium ion capacitor may further include doping the positive electrode and/or the negative electrode with lithium ions.

The doping the lithium ions may be continued until the positive electrode has the potential of 2.0V or less with respect to the lithium ion, and the doping the lithium ions may be continued until the negative electrode has the potential of 0.1V or less with respect to the lithium ion.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals throughout the specification denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration of a lithium ion capacitor according to an exemplary embodiment of the present invention will be described in detail.

The present invention includes graphite as a positive electrode activated material in order to improve capacitance of a lithium ion capacitor.

Carbons are mainly divided into a soft carbon having a graphene structure in which a hexagonal honeycomb plane is arranged in a layered shape to be graphitized and a hard carbon in which a graphene structure is mixed with amorphous portions. In addition, when the carbon has a perfect graphene structure such as natural graphite, it is referred to as graphite.

Technical research into graphite and soft carbon based material has been widely conducted mainly in a lithium ion secondary battery. In particular, research into increasing the number of sites in which lithium ions may be stored to promote high capacitance and research into restraining an electrolyte solution decomposition reaction and an irreversible lithium ion absorption reaction occurring within initial several cycles as much as possible to improve actually usable capacitance have been mostly conducted. The hard carbon has advantages such as high capacitance greatly exceeding 372 mAh/g, which is a theoretical capacity, cycle stability, applicability of various electrolyte solutions, and the like; however, also has disadvantages such as low efficiency in initial charging and discharging and degradation in high-output charging and discharging performance due to non-uniformity of an internal structure of the material. Research into improving the disadvantages has been conducted. In addition, research into a new carbon material has also been conducted toward the addition of a different kind of element, the designing of three-dimensional structure, etc., using the existing soft carbon and hard carbon as a basic material.

Meanwhile, in the exemplary embodiment of the present invention, the graphite or the soft carbon having the graphene structure is used as the positive electrode activated material, wherein the more complete graphene, the more preferable.

When anions such as BF₄⁻ or PF₆⁻, or the like are in contact with the carbon material, they have a strong tendency to be chemically bonded to the carbon atoms. Accordingly, in the lithium ion capacitor in which the positive electrode is made of an active carbon, the anions are adsorbed on a surface of the active carbon to cause reduction in capacitance.

However, when the positive electrode is made of graphite having the graphene structure as in the exemplary embodiment of the present invention, anions such as BF₄⁻ or PF₆⁻ are bonded to the carbon; however, they are introduced between layers to perform the electrochemical reaction thereby making it possible to increase in the capacitance of the capacitor.

In addition, according to another exemplary embodiment of the present invention, an interlayer distance of the graphite used as the positive electrode activated material is preferably 0.35 to 0.38 nm.

The size of the anions such as BF₄⁻ or PF₆⁻ is about 0.34 nm. In order for the anions to be introduced between the layers of the graphite composing the positive electrode, the interlayer distance of the graphite should be 0.35 nm or more. When the interlayer distance is smaller than 0.35 nm, it is difficult for the anions to be introduced into the graphite. Although the anions are introduced into the graphite, if temperature of the capacitor is raised as the charging and discharge of the capacitor is repeated, chemical bonding between the anion and the carbon becomes unstable to make the capacitor expanded, thereby causing defects of the capacitor.

On the other hand, when the interlayer distance exceeds 0.38 nm, a graphene bonding to the graphite itself is weakened to be separated, such that it may be crushed from the positive electrode. As a result, the crushed graphite exists as impurities in the capacitor, thereby occupying only weight without assisting in capacitance increase.

According to an exemplary embodiment of the present invention, in order to make the interlayer distance of the graphite 0.35 to 0.38 nm, the graphite is preferably heat-treated at 650 to 800° C. At this time, heat treatment time is preferably 5 to 8 hours.

When the heat treatment temperature is 650° C. or less or the heat treatment time is shorter than 5 hours, the interlayer distance of the graphite becomes smaller than 0.35 nm, and when the heat treatment temperature exceeds 800° C. or the heat treatment time exceeds 8 hours, the interlayer distance of the graphite exceeds 0.38 nm, such that the interlayer adhesive may be weakened.

Meanwhile, the positive electrode activated material may preferably perform reversible adsorption/desorption of ions in the potential of 2.0 to 3.0V with respect to the lithium ion.

In addition, the positive electrode and the negative electrode are pre-doped with the lithium ions to lower initial potential, thereby making it possible to increase the capacitance.

At this time, the doped positive electrode preferably has the potential of 2.1V or less with respect to the lithium ions and the doped negative electrode preferably has the potential of 0.1V or less with respect to the lithium ion.

Also, the positive electrode according to the exemplary embodiment of the present invention is intercalated with the anions during the charging.

Further, in the positive electrode according to the exemplary embodiment of the present invention, when charging voltage is raised, the capacitance is also largely increased.

Hereinafter, a specific configuration according to an exemplary embodiment of the present invention will be described in detail with reference to experimental examples.

[Manufacturing Positive Electrode]

Graphite having an interlayer distance of 0.35 to 0.38 nm as a positive electrode activated material, acetylene black, and polyethylene vinylidene fluoride were each mixed in the weight ratio of 8:1:1.

Next, the mixture was added to N-methypyrrolidone, which is a solvent, and was agitated to make slurry. Then, the slurry was applied on an aluminum foil having a thickness of 20 μm using a doctor blade method, was primarily dried and then, was cut in a predetermined size (for example, 100×100 mm). The slurry was dried at 120° C. for ten hours under a vacuum before cell assembling.

[Manufacturing Negative Electrode]

Graphite generally available on the market as a negative electrode activated material, acetylene black and polyethylene vinylidene fluoride were each mixed in the weight ratio of 8:1:1. Next, the mixture was added to N-methypyrrolidone, which is a solvent, and was agitated to make slurry. Then, the slurry was applied on a copper foil having a thickness of 10 μm using a doctor blade method, was semi-dried and then, was cut in a predetermined size. At this time, the slurry was dried at 120° C. for five hours under a vacuum before cell assembling.

[Preparing Electrolyte Solution]

An electrolyte solution was prepared by dissolving LiPF₆ at a density of 1.2 mol/L using a mixture of propylene carbonate (PC) and Diethyl Carbonate (DEC) mixed in the weight ratio of 3:7 as a solvent.

[Doping Positive Electrode and/or Negative Electrode with Lithium Ion]

The negative electrode and a lithium metal foil were contacted to be opposite to each other, having a polypropylene nonwoven as a separator therebetween, to be doped with lithium ions. The doping of the lithium ions has continued for about two hours, such that the doping amount of the lithium ions became about 85% of the capacitance of the negative electrode. At this time, potential arrived at a level of 0.1V with respect to the lithium ion.

The positive electrode has progressed in the same scheme. When the potential of the positive electrode arrived at 2.0V with respect to the lithium ion, doping was stopped.

[Assembling Capacitor Cell]

The separator was inserted between the prepared positive and negative electrodes to manufacture a stacked cell. Then, the cell was sealed in the form impregnated together with the electrolyte solution in a receiving case formed of a laminate film and was left for twenty four hours.

The lithium ion capacitor prepared as described above was charged to 5.5V with a constant current and then was discharged to 2.0V with the same current. Capacitance at the time of discharging of a fifth cycle when the constant current discharging as described above was performed was measured. At this time, the calculated capacitance of the lithium ion capacitor was 80 Wh/kg.

As set forth above, the present invention has considerably improved capacitance as compared to a lithium ion capacitor according to the related art.

Therefore, the lithium ion capacitor according to the exemplary embodiment of the present invention may be used as the next-generation capacitor substituting a lead storage battery.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A lithium ion capacitor, comprising:
a positive electrode including a positive electrode activated material;
a negative electrode including a negative electrode activated material; and
an electrolyte solution disposed between the positive electrode and the negative electrode,
wherein the positive electrode activated material includes graphite.

2. The lithium ion capacitor according to claim 1, wherein the graphite has an interlayer distance of 0.35 to 0.38 nm.

3. The lithium ion capacitor according to claim 1, wherein the positive electrode activated material is capable of performing reversible adsorption/desorption of ions in the potential of 2.0 to 3.0V with respect to the lithium ion.

4. The lithium ion capacitor according to any one of claims 1 to 3, wherein the positive electrode and/or the negative electrode are doped with the lithium ions.

5. The lithium ion capacitor according to claim 4, wherein the doped positive electrode has the potential of 2.1V or less with respect to the lithium ion.

6. The lithium ion capacitor according to claim 4, wherein the doped negative electrode has the potential of 0.1V or less with respect to the lithium ion.

7. A manufacturing method of a lithium ion capacitor including a positive electrode including a positive electrode activated material; a negative electrode including a negative electrode activated material; and an electrolyte solution disposed between the positive electrode and the negative electrode, comprising:
heat-treating graphite in preparing the positive electrode activated material.

8. The manufacturing method of a lithium ion capacitor according to claim 7, wherein the heat-treatment is performed at a temperature of 650 to 800° C. for five to eight hours.

9. The manufacturing method of a lithium ion capacitor according to claim 7 or 8, further comprising doping the positive electrode and/or the negative electrode with lithium ions.

10. The manufacturing method of a lithium ion capacitor according to claim 9, wherein the doping the lithium ions is continued until the positive electrode has the potential of 2.0V or less with respect to the lithium ion.

11. The manufacturing method of a lithium ion capacitor according to claim 9, wherein the doping the lithium ions is continued until the negative electrode has the potential of 0.1V or less with respect to the lithium ion.
